(19) United States
(12) Patent Application Publication
(10) Pub. No.: US 2018/0222722 A1
(43) Pub. Date: Aug. 9, 2018

(54) TRANSPORT SYSTEM FOR ROPELESS ELEVATOR HOISTWAY AND METHOD

(71) Applicant: OTIS ELEVATOR COMPANY, FARMINGTON, CT (US)

(72) Inventors: Tadeusz Pawel Witczak, Bethel, CT (US); Cezary Jedryczka, Lniano (PL); Adam Marian Myszkowski, Ostrow Wlkp (PL); Zbigniew Piech, Cheshire, CT (US)

(21) Appl. No.: 15/749,715

(22) PCT Filed: Aug. 9, 2016
(86) PCT No.: PCT/US2016/046146

§ 371 Date: Feb. 1, 2018

Related U.S. Application Data
(60) Provisional application No. 62/204,172, filed on Aug. 12, 2015.

(51) Int. Cl. B66B 9/00

(52) U.S. Cl. CPC B66B 9/003; B66B 11/0407

(57) ABSTRACT

A transport system for a ropeless elevator system hoistway (11) is provided and includes a first lane (13, 15, 17) and a second lane (13, 15, 17). Also included is a parking area located proximate one of the first lane (13,15, 17) and the second lane (13, 15, 17). Further included is a transport assembly for moving an elevator car (14) between the parking area and one of the first and second lane (13, 15, 17). The transport assembly includes a transport structure (80) operatively coupled to a roof (82) of an elevator car (14). The transport assembly also includes a transport beam (84) engageable with the transport structure (80) to support the elevator car (14) by the roof (82) upon alignment of the transport structure (80) and the transport beam (84), the elevator car (14) guided into or out of the parking area by the transport beam (84).

### FIELD OF THE DISCLOSURE

The subject matter disclosed herein relates generally to the field of elevators, and more particularly to a multicar, ropeless elevator system.

### BACKGROUND OF THE DISCLOSURE

Ropeless elevator systems, also referred to as self-propelled elevator systems, are useful in certain applications (e.g., high rise buildings) where the mass of the ropes for a roped system is prohibitive, roped elevator core space can become too large, and there is a desire for multiple elevator cars to travel in a single lane. There exist ropeless elevator systems with multiple lanes in which some lanes are designated for upward traveling elevator cars and some lanes are designated for downward traveling elevator cars. Transfer stations at various locations in the hoistway are used to move cars horizontally between these various upward and downward moving lanes.

Ropeless elevator systems can be used for a variety of applications and users. Certain applications and users have different objectives, requirements, and desires. Further, elevator cars may need to be evaluated for service and maintenance requirements. A system and method that can selectively introduce and remove elevator cars from a ropeless elevator system is desired to optimize performance and service.

### BRIEF DESCRIPTION OF THE DISCLOSURE

According to one aspect of the disclosure, a transport system for a ropeless elevator system hoistway is provided and includes a first lane and a second lane. Also included is a parking area located proximate one of the first lane and the second lane. Further included is a transport assembly for moving an elevator car between the parking area and one of the first and second lane. The transport assembly includes a transport structure operatively coupled to an elevator car structure. The transport assembly also includes a transport beam engageable with the transport structure to support the elevator car by the roof upon alignment of the transport structure and the transport beam, the elevator car guided into or out of the parking area by the transport beam.

In addition to one or more of the features described above, or as an alternative, further embodiments may include that the transport structure includes at least one roller to facilitate movement of the elevator car.

In addition to one or more of the features described above, or as an alternative, further embodiments may include that the at least one roller of the transport structure is motorized.

In addition to one or more of the features described above, or as an alternative, further embodiments may include that the transport beam includes at least one roller to facilitate movement of the elevator car.

In addition to one or more of the features described above, or as an alternative, further embodiments may include that the at least one roller of the transport beam is motorized.

In addition to one or more of the features described above, or as an alternative, further embodiments may include that the parking area comprises a plurality of storage beams, each of the storage beams configured to support the elevator car in the parking area by the roof of the elevator car.

In addition to one or more of the features described above, or as an alternative, further embodiments may include that the transport beam is rotatable to adjust an orientation of the elevator car for alignment with at least one of the plurality of storage beams.

In addition to one or more of the features described above, or as an alternative, further embodiments may include that each of the plurality of storage beams is rotatable to adjust the orientation of the elevator car.

In addition to one or more of the features described above, or as an alternative, further embodiments may include that each of the plurality of storage beams includes at least one roller to facilitate movement of the elevator car.

In addition to one or more of the features described above, or as an alternative, further embodiments may include that the plurality of storage beams are operatively coupled to a ceiling of the parking area.

In addition to one or more of the features described above, or as an alternative, further embodiments may include that each of the plurality of storage beams is supported by at least one beam.

In addition to one or more of the features described above, or as an alternative, further embodiments may include that the plurality of storage beams may be supported by at least one vertical beam.

According to another aspect of the disclosure, a method of transporting an elevator car to a parking area in a ropeless elevator system hoistway is provided. The method includes moving the elevator car within a hoistway lane to a vertical position that aligns a transport structure operatively coupled to a roof of the elevator car with a transport beam. The method also includes translating the elevator car horizontally out of the hoistway lane to engage the transport structure and the transport beam. The method further includes fully supporting the elevator car with the transport beam.

In addition to one or more of the features described above, or as an alternative, further embodiments may include that translating the elevator car comprises propelling the elevator car along the transport beam with at least one motorized roller.

In addition to one or more of the features described above, or as an alternative, further embodiments may include translating the elevator car horizontally from the transport beam to one of a plurality of storage beams located within the parking area.

These and other advantages and features will become more apparent from the following description taken in conjunction with the drawings.

### BRIEF DESCRIPTION OF THE DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 illustrates a multicar ropeless elevator system according to one aspect of the disclosure;

FIG. 2 is a schematic illustration of one car of the multicar ropeless elevator system;

FIG. 3 is a perspective view of a storage area;

FIG. 4 is a perspective view of a transport system for an elevator car; and

FIG. 5 is a perspective view of the transport system according to another aspect.

The detailed description explains embodiments of the disclosure, together with advantages and features, by way of example with reference to the drawings.

### DETAILED DESCRIPTION OF THE DISCLOSURE

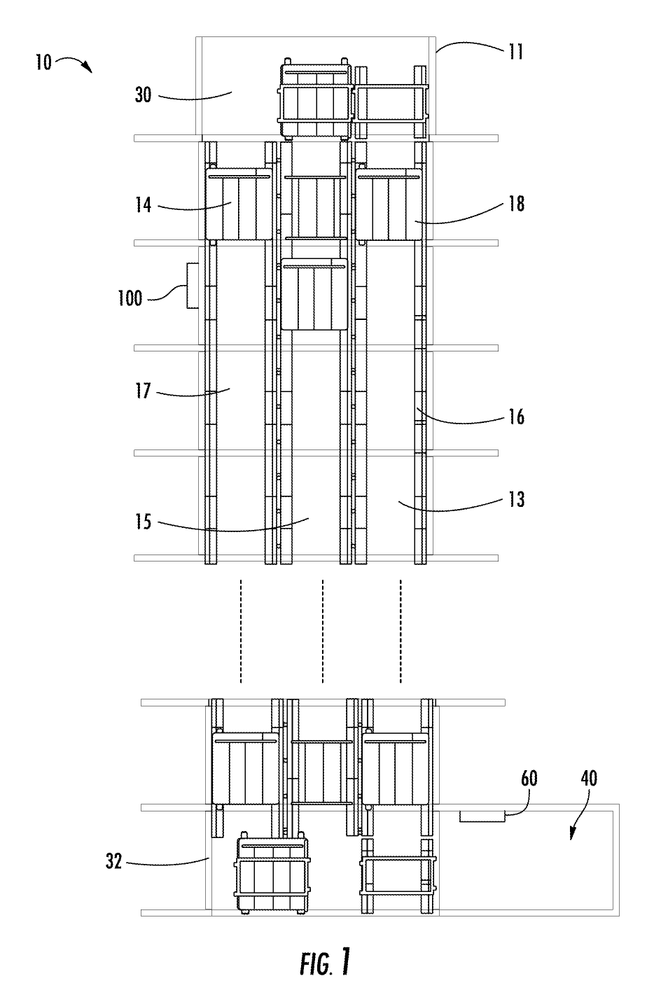

FIG. 1 depicts a multicar, ropeless elevator system 10 in an exemplary embodiment. Elevator system 10 includes a hoistway 11 having a plurality of lanes 13, 15 and 17. In an embodiment, elevator system 10 includes modular components that can be associated to form an elevator system. Modular components include, but are not limited to a landing floor hoistway, a shuttle floor hoistway, a transfer station, a carriage, a parking area, a disengaging mechanism, etc. While three lanes are shown in FIG. 1, it is understood that embodiments may be used with multicar, ropeless elevator systems having any number of lanes. In each lane 13, 15, 17, cars 14 travel in mostly in one direction, i.e., up or down. For example, in FIG. 1 cars 14 in lanes 13 and 17 travel up and cars 14 in lane 15 travel down. One or more cars 14 may travel in a single lane 13, 15, and 17. In an embodiment, cars 14 can move bi-directionally within lanes 13, 15, 17. In an embodiment, lanes 13, 15, 17 can support shuttle functionality during certain times of the day, such as peak hours, allowing unidirectional, selective stopping, or switchable directionality as required. In an embodiment, lanes 13, 15, 17 can include localized directionality, wherein certain areas of lanes 13, 15, 17 and hoistway 11 are assigned to various functions and building portions. In an embodiment, cars 14 can circulate in a limited area of hoistway 11. In an embodiment, cars 14 can operate at a reduced velocity to reduce operating and equipment costs. In other embodiments, hoistway 11 and lanes 13, 15, 17 can operate in a mixed mode operation wherein portions of hoistway 11 and lanes 13, 15, 17 operate normally (unidirectional or bidirectional) and other portions operate in another manner, including but not limited to, unidirectional, bidirectional, or in a parking mode. In an embodiment, parked cars can be parked in lanes 13, 15, 17 when lanes are designated for parking.

In an embodiment, the elevator system 10 can include an upper transfer station 30 (e.g., located above the top floor) which can allow for movement of an elevator car 14 between lanes 13, 15 and 17. In an embodiment, the upper transfer station 30 and a lower transfer station 32 in addition to other transfer stations and loading stations 50 can be disposed at any suitable location. It is understood that upper transfer station 30 may be located at the top floor, rather than above the top floor. In an embodiment, a lower transfer station 32 can be located below or proximate to the first floor which can allow for movement of an elevator car 14 between lanes 13, 15 and 17. Any method for imparting motion to the elevator cars 14 to move elevator cars 14 between lanes 13, 15 and 17 can be employed in a transfer station 30, 32. For example, such methods can include the primary propulsion system of the elevator car 14, a separate propulsion system adapted for movement of an elevator car 14 through the transfer station 30, or a combination thereof. It is understood that lower transfer station 32 may be located at the first floor, rather than below the first floor. Although not shown in FIG. 1, one or more intermediate transfer stations may be used between the first floor and the top floor. Intermediate transfer stations are similar to the upper transfer station 30 and lower transfer station 32. Additionally, the illustrated embodiment is merely one example and it is to be appreciated that the system may include transfer station(s) at any desired location.

Cars 14 can be propelled using, for example, a linear motor system having a primary, fixed portion 16 and a secondary, moving portion 18. One or more fixed portions 16 can be mounted in lanes 13, 15 and 17. One or more moving portions 18 can be mounted on cars 14. One of the motor portions can be supplied with drive signals to control movement of cars 14 in their respective lanes. In an embodiment, lanes of the hoistway 11 can be shut down or restricted based on operator input or elevator system conditions.

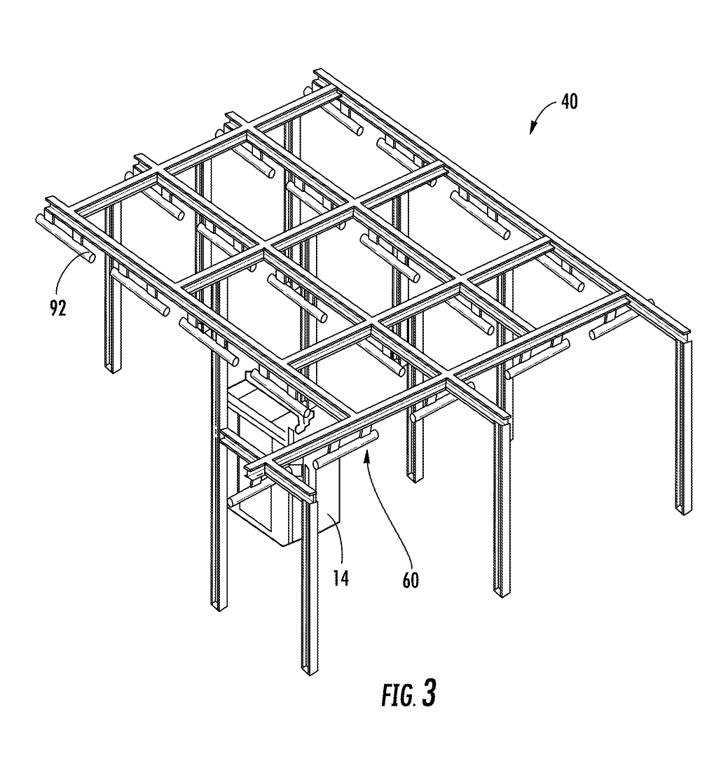

In an embodiment, elevator system 10 includes a transport system 60 (FIG. 3) to transfer cars 14 in and out of hoistway 11 to or from a storage area 40. In an embodiment, the status and health of individual cars 14 can be evaluated in the storage area, subjected to maintenance tasks, and/or parked in the storage area 40 when not needed. In an embodiment, a supervisory controller 100 can provide determinations or an interface regarding the introduction, removal and management of cars 14. In an embodiment, the supervisory controller 100 may provide control or an interface to determine the management and storage of cars 14 in storage area 40.

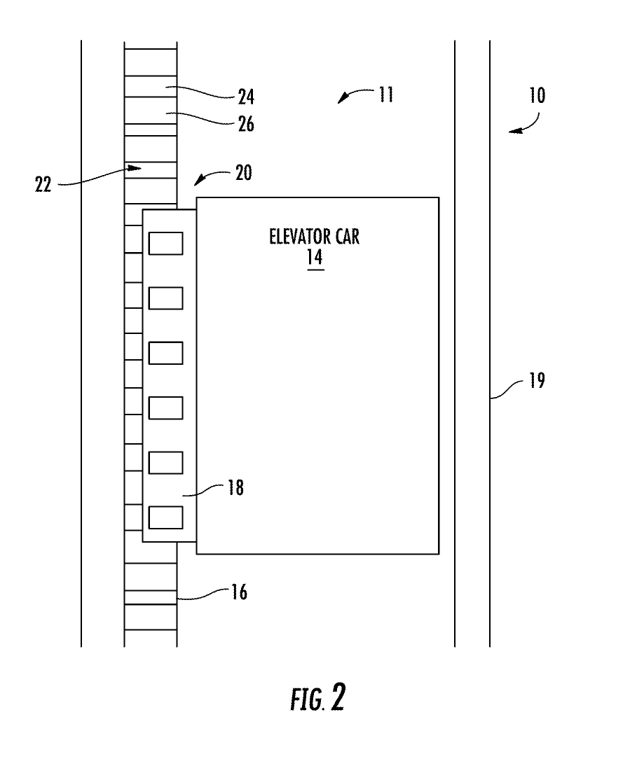

Referring to FIG. 2, illustrated is another view of the elevator system 10 including an elevator car 14 that travels in hoistway 11. Elevator car 14 can be guided by one or more guide structures 24 extending along the length of hoistway 11. The guide structure 24 may be affixed to a hoistway wall, a propulsion device, a structural member 19, or stacked over each other. For ease of illustration, the view of FIG. 2 only depicts a single side guide structure 24. However, there may be two or more guide structures 24 positioned, for example, on opposite sides of the elevator car 14. Elevator system 10 employs a vertical propulsion system 20, where the same placement variations apply to vertical propulsion stationary portion 16 placed in the hoistway. Vertical propulsion stationary portion 16 includes multiple segments 22. Segments 22 may be affixed to a hoistway wall, a guide structure, a carriage structural member 19, stacked over each other, or a combination including at least one of the foregoing. Propulsion moving portion 18 may be affixed to a car frame, may be a structural member of a car frame, or a combination thereof. Any number of propulsion moving portions 19 may be affixed to a car.

Referring to FIGS. 3-5, the transport system 60 is illustrated in greater detail. The transport system 60 can be utilized within the elevator system 10 to introduce and remove cars 14 from the hoistway 11. The transport system 60 may be disposed in any suitable location. In an embodiment, the elevator system 10 may include multiple transport systems to add and remove cars 14 at multiple locations within a hoistway 11. In an embodiment, the transport system 60 can work in conjunction with transfer stations 30 or 32 to provide transfer functionality and remove and introduce cars 14 from hoistway 11. The transport system 60 is capable of moving elevator cars between one or more hoistway 11, a transfer station, a parking or storage area, or a combination including at least one of the foregoing. Furthermore, it is contemplated that multiple interface regions (i.e., entry and/or exit) may be provided to allow the elevator cars to be moved into a region, such as the storage area 40, then removed from the storage area via a different interface. This provides flexibility and may even allow the cars to be transported between an interior structure and an exterior structure (e.g., outdoors).

In an embodiment, the transport system 60 introduces cars 14 stored in the storage area 40 into the hoistway 11. The transport system 60 can remove cars 14 from the hoistway 11 to the storage area 40. Cars 14 may be introduced and removed to meet demand, satisfy maintenance requirements, for emergency repair, as well as facilitate the use and removal of a specialized car. The transport system 60 allows for safe engaging and disengaging of cars 14 between an active elevator system and the storage area 40. During operation, if a car 14 is to be removed, car 14 will enter an interface region of the hoistway 11 that is located proximate the storage area 40. In an embodiment, the car 14 can pass through the hoistway interface without any change in performance and speed. Advantageously, lane continuity within hoistway 11 is maintained, requiring less or no alternative bypass paths or loops for car 14 travel.

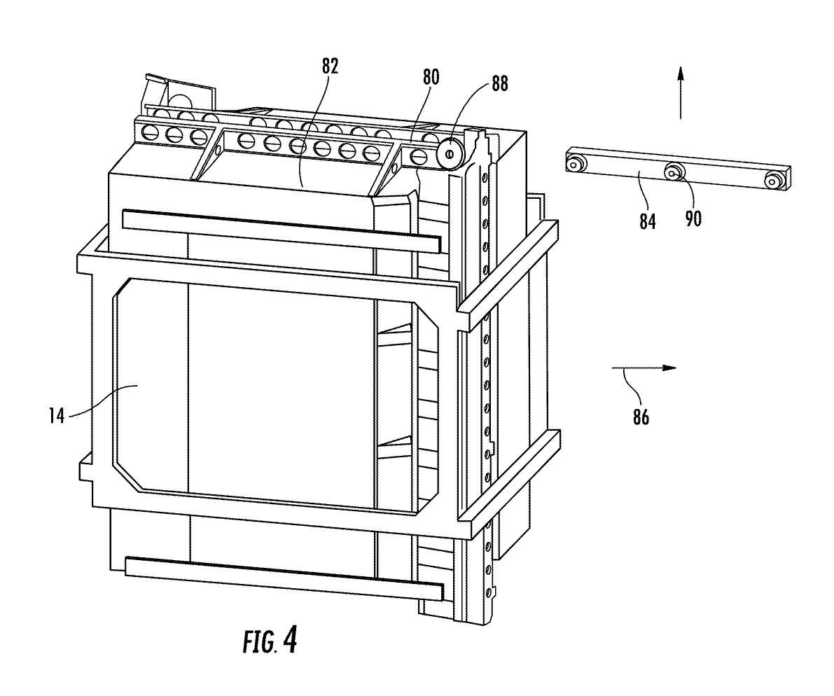

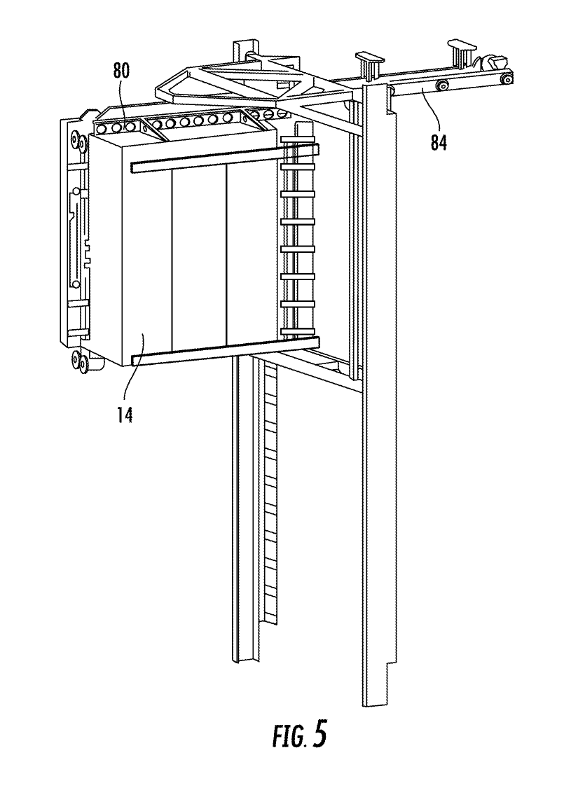

Referring to FIGS. 4 and 5, aspects of the transport system 60 are illustrated in greater detail. The transport system 60 includes a transport structure 80 operatively coupled to a frame structure that is integrated with the elevator car 14. The coupling location of the transport structure 80 to the frame structure can be proximate an upper region of the elevator car 14, e.g., the roof 82 of the elevator car 14. The transport structure 80 is any structure that is configured to directly or indirectly couple to the frame structure. For example, the transport structure 80 can include a beam, rail or the like. The transport structure 80 may extend partially or fully along a length or width of the roof 82 of the car 14. Working in conjunction with the transport structure 80 is a transport beam 84 (also shown in FIG. 3). The transport structure 80 and the transport beam 84 are configured to be substantially aligned with each other to facilitate transport of the elevator car 14 between a lane of the hoistway 11 and the storage area 40. In an embodiment, beam 84 is an interface beam that facilitates transfer from the storage area 40 to and from the hoistway 11 or another zone, such as a transfer station. In an embodiment, beam 84 is moveable in a vertical manner, a horizontal manner, a rotational manner, or a combination including at least one of the foregoing. Alternatively, the beam 84 may be stationary. In embodiments where translation and/or rotation of the transport beam 84 is enabled, the additional degrees of freedom of motion allow transport of the elevator car in different interface configurations. As shown in FIG. 4, upon alignment of the transport structure 80 and the transport beam 84, the elevator car 14 is moved in a first direction (e.g., horizontal) represented with arrow 86. In some embodiments, movement in only the first direction 86 disposes the elevator car 14 into the storage area 40. In other embodiments, movement in a second direction (e.g., vertical) is needed to lift or lower the car 14 to another level that aligns the car 14 with the storage area 40. Alternatively, movement in a vertical direction followed by a horizontal direction may be employed. In yet another alternative, only one direction may be required to transport the elevator car between two different zones (e.g., hoistway 11 and storage area 40).

Movement of the elevator car 14 to or from the transport beam 84 may be facilitated by any suitable propulsion mechanism. In some embodiments, propulsion may be achieved with one or more slider surfaces. In the illustrated embodiments, the slider surface(s) comprise a roller 88 disposed on the transport structure 80 and a roller 90 disposed on the transport beam 84. It is to be appreciated that roller(s) may be disposed on only one of the transport structure 80 and the transport beam 84 or may be disposed on both the transport structure 80 and the transport beam 84. Regardless of the precise positioning of the roller(s), the rollers may be motorized and/or computerized to facilitate powered propulsion of the elevator car into a desired position. It is to be further understood that the slider surfaces may comprise alternative structures that facilitate movement of the elevator car 14. By way of non-limiting example, the slider surface may be a bearing arrangement or the like. Alternatively, a chain-driven assembly may be used to move the elevator car 14.

Referring again to FIG. 3, the storage area 40 is shown and represents any suitable area, including areas of hoistway 11 not currently utilized. In an embodiment, when cars 14 are in storage area 40, cars 14 can be held for varying periods of time based on demand for the cars in the hoistway 11 and for maintenance purposes. Cars 14 may be stored and maintained in certain positions that allow for increased accessibility for maintenance and repair. Cars 14 can be delivered to and retrieved from storage area 40 with the transport system 60 described above. In an embodiment, the storage area 40 can include one storage beam 92. As shown, a plurality of storage beams 92 may be located in the storage area 40. The plurality of storage beams 92 can be operatively coupled to the ceiling of the storage area 40 in some embodiments and hang therefrom. In other embodiments, each of the storage beams 92 may be supported by at least one support structure, such as vertical beams or walls. The storage beams 92 can provide numerous locations from which the elevator car 14 may be stored within the storage area 40.

In operation, when transporting a car to the storage area 40, the elevator car is moved into engagement with the transport beam 84 and supported therefrom. Engagement may be facilitated in any suitable manner, such as overlapping beams, clamping, cooperating engagement features disposed in the storage beam and the transport beam 84 (e.g., female and male engagements such as dove tail joints, projections, indentations, and the like) or the like. The transport beam 84 can be aligned with one of the storage beams 92 and the transport structure 80 can be moved into engagement with one of the storage beams 92 to be supported therefrom. The car may be moved to a subsequent storage beam 92, as needed. The transport beam 84 and/or the plurality of storage beams 92 can be rotatable in some embodiments to allow for additional parking and storage flexibility or to place the elevator car 14 in a more accessible position for maintenance to be performed. Advantageously, cars 14 can be stored in any order and retrieved in any order to allow access and ease of dispatch.

While the disclosure has been described in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that aspects of the disclosure may include any number of the described embodiments. Accordingly, the disclosure is not to be seen as limited by the foregoing description, but is only limited by the scope of the appended claims. The terms “a” and “an” and “the” herein do not denote a limitation of quantity, and are to be construed to cover both the singular and the plural, unless otherwise indicated herein or clearly contradicted by context.

1. A transport system for a ropeless elevator system hoistway comprising:
a lane;
a parking area located proximate one of the first lane and the second lane; and
a transport assembly for moving an elevator car between the parking area and the lane, the transport assembly comprising:
a transport structure operatively coupled to a frame structure of an elevator car proximate a roof of the elevator car; and
a transport beam engageable with the transport structure to support the elevator car by the frame structure upon alignment of the transport structure and the transport beam, the elevator car guided into or out of the parking area by the transport beam.

2. The transport system of claim 1, wherein the transport structure includes a transport structure slider surface to facilitate movement of the elevator car.

3. The transport system of claim 2, wherein the transport structure slider surface is motorized.

4. The transport system of claim 1, wherein the transport beam includes a transport beam slider surface to facilitate movement of the elevator car.

5. The transport system of claim 4, wherein the transport beam slider surface is motorized.

6. The transport system of claim 1, wherein the parking area comprises a storage beam configured to support the elevator car in the parking area by the frame structure of the elevator car.

7. The transport system of claim 6, wherein the transport beam is rotatable to adjust an orientation of the elevator car.

8. The transport system of claim 6, wherein the storage beam is rotatable to adjust the orientation of the elevator car.

9. The transport system of claim 6, wherein the storage beam includes a storage beam slider surface to facilitate movement of the elevator car.

10. The transport system of claim 6, wherein the storage beam is operatively coupled to a ceiling of the parking area, a wall of the parking area, a floor of the parking area, a vertical structure of the parking area, or a combination comprising at least one of the foregoing.

11. The transport system of claim 6, wherein the storage beam is supported by at least one beam.

12. The transport system of claim 11, wherein the plurality of storage beams is supported by at least one vertical structure.

13. A method of transporting an elevator car to a parking area in a ropeless elevator system hoistway, the method comprising:
moving the elevator car within a hoistway lane to a position that aligns a transport structure operatively coupled to a frame structure of the elevator car with a transport beam, the frame structure located proximate a roof of the elevator car;
engaging the transport structure and the transport beam;
supporting the elevator car with the transport beam; and
moving the elevator car to a desired location.

14. The method of claim 13, wherein translating the elevator car comprises propelling the elevator car along the transport beam with a motorized slider surface.

15. The method of claim 13, further comprising moving the elevator car from the transport beam to a storage beam located within the parking area.
